(19) United States
(12) Patent Application Publication
(10) Pub. No.: US 2026/0364883 A1
(43) Pub. Date: Nov. 19, 2026

(54) METHODS AND APPARATUS FOR CONTROLLED REUSE OF BUILD MATERIAL

(71) Applicant: Stratasys Powder Production Ltd., Nottingham (GB)

(72) Inventors: Torben LANGE, Nottingham (GB); Anders HARTMANN, Nottingham (GB); Simon BAK, Nottingham (GB)

(21) Appl. No.: 19/158,813

(22) PCT Filed: Feb. 23, 2024
(86) PCT No.: PCT/GB2024/050505

§ 371 Date: Aug. 21, 2025

(30) Foreign Application Priority Data
Feb. 24, 2023 (GB) 2302692.5

(51) Int. Cl. B29C 64/357; B33Y 40/00; G05B 19/418

(52) U.S. Cl. CPC B29C 64/357; B33Y 40/00; G05B 19/4183; G05B 2219/31376; G05B 2219/49023

(57) ABSTRACT

A post processing station, system and method for recovering unfused build material from a build volume produced by a 3D printer. The post processing station receives a build volume and an electronic tag storing at least one of a build material ID and a source ID or a link to at least one of said IDs stored on a data storage device. The post processing station includes a controller having an electronic tag reader in communication with a validation data storage device. The controller reads the tag and obtains the build material and/or source ID; determines whether the obtained ID(s) corresponds to an allowable ID; and upon determining that the tag corresponds to an allowable ID, accepts the unfused build material for dosing. Upon determining that the obtained ID does not correspond to an allowable ID, the controller generates an alert that the obtained ID cannot be verified.

### FIELD OF THE INVENTION

The present disclosure relates to methods and apparatus for controlled reuse of build material in an additive manufacturing system or facility. More particularly, the present disclosure relates to a post processing station for recovering unfused build material from a build volume produced by a 3D printer, an additive manufacturing system that includes such a post processing station and one or more 3D printers, and a method for controlling the provision of a build volume produced by such a 3D printer to such a post processing station, and related material handling considerations. The method and apparatus may be particularly beneficial in systems comprising several 3D printers and optionally several post processing stations, such as in an industrial setting.

### BACKGROUND

As additive manufacturing (e.g. industrial 3D printing) technologies continue to evolve, ever more challenging applications require new solutions. Repeatability and reliability of the mechanical and visual quality of objects over a build process requires consistency in the properties of build material for each layer of an object to ensure that the thermal process to which the layers are subjected remains the same. In additive manufacturing technologies that are powder bed based, the unfused powder may be recycled. This is a significant advantage in for example print and sinter and laser sintering applications. The amount of reused material typically requires careful management because a change in the property of build material due to for example a change in reused to fresh powder ratio can affect the melting temperature of the build material. This may lead to overheating or underheating of the fused layers in powder bed fusion processes. It is known to provide authentication means to the material that is provided to an additive manufacturing apparatus (e.g. an industrial 3D printer) so that the powder type may be tracked. Such information may be provided to a powder cartridge at a post processing station that recovers the reused powder from a build it receives from the additive manufacturing apparatus, and refills the powder cartridge with a specified reused amount and fresh amount. Powder tracking becomes more and more challenging in industrial manufacturing processes where multiple apparatus are involved in the work flow, and especially where the manufacturing process requires certification. Therefore, improvements are needed to provide solutions to provide improved automated systems for tight control over the build material and processes.

### SUMMARY

The invention is set out in the appended independent claims, while particular embodiments of the invention are set out in the appended dependent claims.

### BRIEF DESCRIPTION OF THE DRAWINGS

Reference is now directed to the drawings, in which:

FIG. 1 is a flow diagram illustrating controlled flow of build material through an additive manufacturing system comprising a 3D printer and a post processing station, and build material associated with an electronic tag;

FIG. 2 is a flow chart of the method according to the invention;

FIG. 3 is a schematic cross-section through a post processing station configured to carry out the method according to the invention;

FIG. 4 is a schematic cross-section through an additive manufacturing apparatus configured to provide data on a tag for the use in the post processing station;

FIG. 5 is a variant of FIG. 1 in which the system comprises two 3D printers;

FIG. 6 is a block diagram illustrating controlled flow of build material through a system comprising a plurality of 3D printers and one post processing station;

FIG. 7 is a block diagram illustrating controlled flow of build material through a system comprising a plurality of 3D printers and a plurality of post processing stations;

FIG. 8 is a block diagram illustrating a controlled flows of different build material through two respective additive manufacturing systems;

FIG. 9 is a variant of FIG. 2 illustrating a full cycle of control of build material reuse; and

FIG. 10 is a sequence of diagrams illustrating in detail the different stages of controlled flow of build material through an additive manufacturing system.

In the drawings, like elements are indicated by like reference numerals throughout.

### DETAILED DESCRIPTION

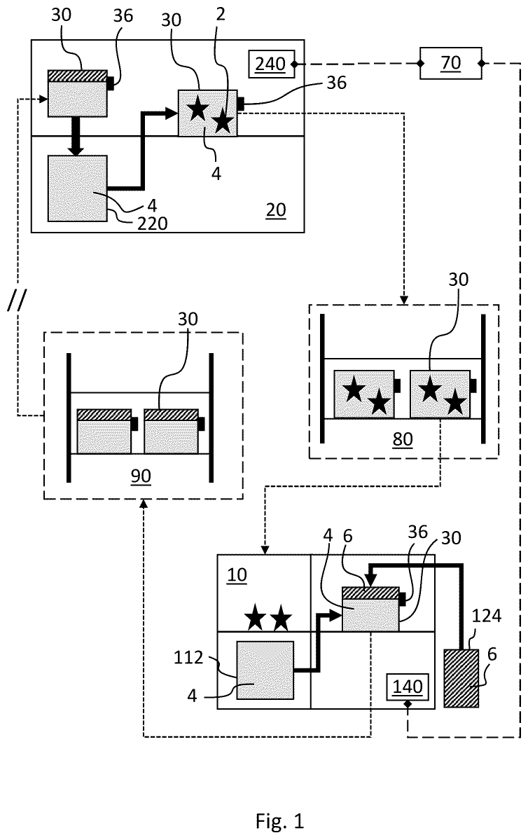

Improved throughput rates of parts through additive manufacturing apparatus have opened up opportunities for industrial manufacturing, which in turn requires industrial solutions for unpacking and recycling of unfused build material. This may include verified dosing of recycled and fresh material to provide a consistent material of known properties to an additive manufacturing apparatus. For example, a nylon material such as PA11 or PA12 may be reused at a ratio of 70% or 80% mixed with fresh build material. In additive manufacturing systems in which a quality of build material is to be controlled in semi-automated or automated solutions of integrating additive manufacturing apparatus and post processing stations, contamination of build material should also be avoided. Build material contamination may include unintentional mixing-in of another build material. This may result in reduced part quality or even failure of a build process. In addition, cleaning the apparatus and/or post processing station results in significant down time. Avoiding contamination-related mistakes becomes increasingly complex where a post processing station is to be associated with a plurality of additive manufacturing apparatuses and/or a plurality of build containers used to transport each build volume from an additive manufacturing apparatus to the post processing station, and optionally after refilling with a supply of build material from the post processing station to the additive manufacturing apparatus. Furthermore, different build materials may be processed in dedicated multiple post processing stations, each for a different material, and each associated with a respective one or more additive manufacturing apparatus. Herein, the additive manufacturing apparatus is also referred to as ‘3D printer’, which may comprise types of powder bed fusion apparatus including laser sintering and print and fuse apparatus. The flow of build material through such additive manufacturing systems requires improved control, as may be provided by an additive manufacturing system, its components and a method of their use according to the invention as will now be described with reference to FIGS. 1 to 10.

FIG. 1 is a flow diagram illustrating the controlled flow of build material through the system in which the components are schematically depicted. The system comprises a 3D printer 20 and a post processing station 10, and a build container 30 comprising an electronic tag 36. The 3D printer is configured to generate a build volume comprising one or more 3D objects 2 and unfused build material 4, which may be provided in the build container 30 for transfer to the post processing station. The 3D printer comprises a printer controller 240 configured to write to the electronic tag at least one of a source ID and a build material ID, or a link to at least one of said IDs stored on a data storage device (e.g. on a remote server/database). The source ID may for example be a 3D printer ID identifying the 3D printer 20 that generated the build volume, and the build material ID may identify one or more properties of the unfused build material 4. The build volume within the build container 30 is removed from the 3D printer, and provided to the post processing station 10 either directly or after temporarily being stored at a cooling station 80. The cooling station 80 may be configured to store several build containers 30 comprising respective build volumes generated by the 3D printer, each build container 30 having an electronic tag 36 storing a source ID and/or a build material ID, and/or a link to one or both of the said IDs stored on the data storage device, such as storage device 70 which may be a remote database.

The post processing station 10 is in general configured to receive the build volume, depowder the objects 2 from it and recover unfused powder 4 for reuse. The post processing station comprises a controller 140 having an electronic tag reader and in communication with a validation data storage device. The validation data storage device may be an internal memory of the post processing station, or a database accessible via a network, such as storage device 70. The validation data storage device comprises one or more stored allowable build material IDs and/or one or more stored allowable source IDs. The controller 140 of the post processing station 10 is configured to read the electronic tag 36 of the build container 30, and to thereby obtain the build material ID and/or source ID stored thereon or linked thereto. By comparing the obtained build material ID and/or the obtained source ID with said one or more stored allowable build material IDs and/or said one or more stored allowable source IDs, the controller 140 is configured to determine whether the obtained build material ID and/or the obtained source ID on the electronic tag 36 corresponds to one of the allowable build material IDs and/or one of the allowable source IDs. Upon determining that the obtained build material ID and/or the obtained source ID does not correspond to one of the allowable build material IDs and/or to one of the allowable source IDs, the controller 140 is configured to generate an alert indicating that the obtained build material ID and/or the obtained source ID cannot be verified. Otherwise, upon determining that the obtained build material ID and/or the obtained source ID does correspond to one of the allowable build material IDs and/or to one of the allowable source IDs, the build volume is loaded manually or automatically into the post processing station 10 and the objects 2 are depowdered. The unfused build material 4 is recovered and reused together with a predefined amount of fresh build material 6 from a supply tank 124 to generate a dosed volume. This is indicated by the bold arrows within the schematic of the post processing station 10. The dosed volume may be dosed into the or a further build container 30 having an electronic tag 36. The same container may be used to transfer the build volume from the 3D printer 10 to the post processing station 10 and the dosed volume from the post processing station to the 3D printer. The controller 140 may be configured to write to the tag a new build material ID and/or a new source ID, or a link to the said new build material ID and/or the source ID stored on a data storage device (for example the remote server/database, such as data storage device 70). The dosed volume comprises a predefined ratio of unfused and fresh build material which may be identified by a new build material ID. Furthermore, the batch number and type of fresh build material in the supply tank 124 and/or the origin of the unfused build material may be identified by the new build material ID. The source ID may identify the 3D printer that is to receive the dosed volume, or it may comprise several 3D printer IDs for which the dosed volume is an allowable dosed volume.

Next, the build container 30 comprising the dosed volume is removed from the post processing station 10. The build container 30 comprising the dosed volume may be stored temporarily at a build material storage station 90 or be provided directly to the 3D printer, as indicated by the dotted arrow. Upon providing the dosed volume 34 to the 3D printer 20, the printer controller 240 of the 3D printer may read the electronic tag 36 of the build container 30 and thereby obtain the source ID and/or the new build material ID stored thereon or linked thereto. The printer controller 240 may be configured to compare the obtained build material ID and/or the obtained source ID to an allowable build material ID and/or an allowable source ID, which may be the ID identifying that 3D printer 20. The said allowable IDs may be stored on a printer verification data storage device which may be internal to the 3D printer or on a remote database, such as storage device 70. Upon determining that the obtained build material ID and/or the obtained source ID does not correspond to one of the allowable build material IDs and/or the allowable source ID, the printer controller 240 may be configured to generate an alert indicating that the obtained build material ID and/or the obtained source ID cannot be verified. Otherwise, upon determining that the obtained build material ID and/or the obtained source ID corresponds to one of said allowable IDs, the dosed volume is released into the build material tank 220 of the 3D printer. The tank 220 may be configured to mix the build material; however, this may not be necessary in examples in which the post processing station or an intermediate device is configured to mix the dosed volume before it is provided to the 3D printer. Next, a new build volume is generated by the 3D printer from the dosed volume in the tank 220, and indicated by the bold arrows within the schematic of the 3D printer 20, and the cycle is repeated.

After determining that the one or more said obtained IDs correspond to one of the said allowable IDs, the controller 140 of the post processing station and/or the printer controller 240 may be configured to store the obtained build material ID and/or the source ID on the respective data storage device, which may be comprised in the shared data storage device 70, and may erase the data on the tag 36. When the tag is reused in association with a new build volume or a new dosed volume, the respective controller may be configured to write to the tag the build material ID and/or the source ID, and/or a link to the said build material ID and/or said source ID as obtained from the respective or shared data storage device. In this way, the flow of build material may be traced and verified. In particular, verification of build material entering the post processing station that is to be used for subsequent dosing of further dosed volumes may be beneficial in manufacturing processes in which the mechanical properties of 3D parts are to be tightly controlled, for example to allow certification of critical components for the automotive or aerospace industry.

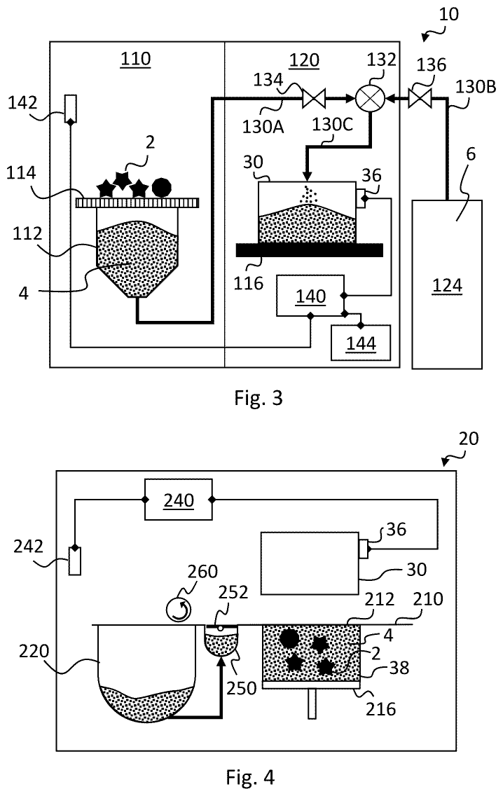

FIG. 3 is a schematic cross section front view through a post processing station 10 configured to carry out the method according to the invention. In more detail, the post processing station 10 comprises a depowdering section 110 to which the build container 30 provides a build volume for unpacking. For simplicity, the build container 30 is not shown at the depowdering section in FIG. 3. The post processing station comprises an electronic tag reader 142 configured to read the electronic tag 36 of the build container 30, preferably before the build material is released from the build container into the depowdering section. The controller 140 is connected to the reader 142 to compare the build material ID and/or a source ID to the one or more allowable IDs stored on the validation data storage device as described above. Upon determining that the obtained build material ID and/or the obtained source ID does not correspond to one of said allowable IDs, the controller generates an alert, for example a sound alert and/or a warning displayed at a user interface 144 of the post processing station 10, indicating that the build volume, or the unfused build material within the build volume, is not allowable for use in that post processing station. The alert may comprise the controller 140 controlling the post processing station 10 to refuse the build volume to be released and entered into the depowdering section 110. If the one or more IDs corresponds to an allowable ID, the build volume may be loaded into the depowdering section. The controller 140 may control the depowdering section to automatically allow the build volume to enter, and to cause the objects 2 to be separated from unfused build material 4 by for example directing one or more air streams towards the build volume (not shown). The unfused build material 4 is passed through a mesh 114, by for example through vibrating the mesh 114, and into a recovery tank or recovery hopper 112. The depowdered parts 2 remain on the surface of the mesh as shown. The unfused build material 4 in the recovery hopper 112 may next be transported within the post processing station for reuse. As shown in FIG. 3, the post processing station further comprises a dosing section 120. A build container 30 to receive a dosed volume and comprising an electronic tag 36 has been provided to the dosing section 120. The dosing section 120 comprises metering means such as a load cell 116 configured to accept a build container 30, and a build material pump 132, or other suitable means, for conveying build material along a build material transport path 130. The build material transport path comprises a reuse build material transport path 130A from the recovery hopper 112 via a first valve 134 to the build material pump 132, a fresh build material transport path from a supply container 124 via a second valve 136 to the pump 132, and an outlet path 130C from the pump to the build container 30. The build material pump is therefore coupled to the recovery hopper 112 via the first valve 134, and to the supply container 124 via the second valve 136. The valves 134, 136 are controlled to open the reused build material transport path 130A, 130C while shutting the fresh build material flow path 130B so as to pump unfused build material 4 from the recovery hopper into the build container 30, and to open the fresh build material transport path 130B, 130C while shutting the reused build material transport path 130A so as to pump fresh build material 6 from the supply container 124 to the build container 30 in a controlled manner.

To control the amount of material refilled into the build container 30, the container is placed on a load cell 116 of the dosing section, configured to measure the weight of the build material inside the build container. The controller 140 is coupled to the load cell 116 and to the build material pump 132 and valves to control the transport paths and monitor the weight of the unfused build material transferred into the container 30. With the second valve 136 closed and the first valve 134 open, the controller controls the pump 132 to pump a predefined first weight of unfused reuse build material into the build container 30. When the controller determines that the load cell indicates that the predefined weight of reused material has been reached, the controller controls the first valve 134 to close and the second valve 136 to open. Fresh build material is allowed to flow into the build container 30 until the controller determines that the load cell 116 indicates that the predefined weight of reused material has been reached. The predefined weight of reuse material and the predefined weight of fresh build material is chosen so as to achieve a specific ratio of reused to fresh build material. The controller may next write a new build material ID to the electronic tag 36 on the build container 30 identifying the reused build material and the fresh build material, and/or a new source ID identifying the 3D printer for which the dosed volume is intended. The build material ID may comprise identification of the material name, and/or the dosed ratio of reused and fresh material, and/or the batch number of fresh material. It may further indicate a level of ageing the number of reused cycles of the unfused build material.

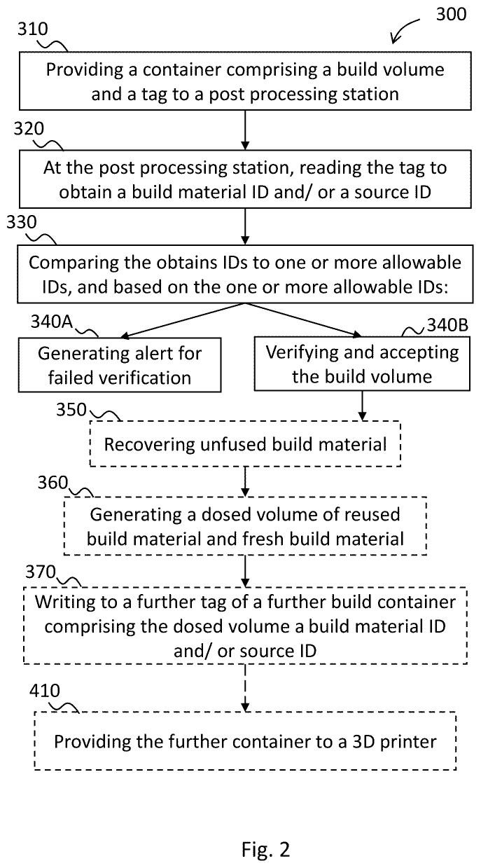

Provided therefore is a post processing station 10 for recovering unfused build material 4 from a build volume produced by a 3D printer, the build volume comprising one or more 3D objects 2 and unfused build material 4. The post processing station 10 comprises a receiving section configured to receive a build container 30 comprising the build volume and an electronic tag 36. The electronic tag 36 stores at least one of a build material ID and a source ID, or a link to at least one of said IDs stored on a data storage device such as an internal memory, or a remote server or database accessible by the controller via a network, such as data storage device 70 indicated in FIG. 1. The source ID may be one or more of a 3D printer ID identifying the 3D printer that generated the build volume 38, a build container ID identifying the build container, and a post processing station ID identifying the post procession station for which the build volume is intended. The build material ID identifies one or more properties of the unfused build material 4 of the build volume. The post processing station 10 comprises a controller 140 having an electronic tag reader 142 in communication with a validation data storage device as described above. The validation data storage device may be the same as the data storage device. The validation data storage device comprises one or more stored allowable build material IDs and/or one or more stored allowable source IDs. The controller is configured to carry out steps illustrated by a method 300 of controlling the flow of build material through the post processing station 10 as illustrated by the flow chart of FIG. 2.

At block 310, upon providing the build container 30 comprising the build volume 38 and the electronic tag 36 to the post processing station 10, the electronic tag storing at least one of a build material ID and/or a source ID, or a link to a data storage device storing the at least one of the build material ID and/or the source ID; the controller 140 is configured to:
At block 320, read the electronic tag 36 and thereby obtain the build material ID and/or source ID stored thereon or linked thereto;
At block 330, compare the obtained build material ID and/or the obtained source ID with said one or more stored allowable build material IDs and/or said one or more stored allowable source IDs, and determine whether the obtained build material ID and/or the obtained source ID corresponds to one of the allowable build material IDs and/or one of the allowable source IDs; and either:
   at block 340A, upon determining that the obtained build material ID and/or the obtained source ID does not correspond to one of the allowable build material IDs and/or to one of the allowable source IDs, to generate an alert indicating that the obtained build material ID and/or the obtained source ID cannot be verified; or
   at block 340B, upon determining that the obtained one or more said IDs corresponds to respective one or more allowable IDs, indicating that the obtained build material ID and/or the obtained source ID corresponds to one of the allowable build material IDs and/or to one of the allowable source IDs, to permit the obtained build volume to be accepted into the post processing station. The controller may for example indicate that the build volume may be accepted into the post processing station.

Block 340A may comprise preventing the user from entering, or preventing an automatic transfer of, the unverified build volume into the post processing station. Block 340B may comprise generating a notification to the user that the build volume is an allowable build volume, and/or allowing the user to enter the verified build volume manually, or automatically causing the verified build volume to be transferred, into the post processing station 10. In this way, the flow of build material into the post processing station may be controlled. If the build volume is verified and automatically transferred, or manually entered, into the post processing station 10, optionally the controller 140 may cause the build material ID on the electronic tag to be erased, and optionally also the source ID. Preferably, where a build container ID identifying the build container is stored on the tag, the build container ID may not be erased but may be stored permanently on the tag.

Next, at block 350, the controller may control the post processing station to recover unfused build material from the build volume as the objects are depowdered. Therefore, upon verifying the build material ID and/or the source ID is allowable, the controller 140 of the post processing station may further be configured to control the post processing station to automatically release or allow the release of the build volume into the depowdering section of the post processing station. In the depowdering section, unfused build material is separated from the one or more objects and flows into a temporary storage tank, hopper or buffer tank for reuse.

At block 360, at the dosing section, a predetermined reuse amount of the recovered unfused build material is dosed to the or a further build container; and a predetermined fresh amount of the fresh build material is dosed to said build container. The same or a further build container may be provided to the dosing section to receive the dosed volume. Optionally, the post processing station may be configured to verify that the build container 30 that is to receive the dosed volume is an allowable build container, for example by comparing the source ID such as a build container ID and/or 3D printer ID stored on the electronic tag of the build container to an allowable ID, and verifying the build container and allowing it to receive the dosed volume if the stored build container ID and/or 3D printer ID is an allowable ID. The allowable IDs may be stored on the validation data storage device of the post processing station. Thus the recovered build material is reused to generate a dosed volume of reused to fresh build material at a predefined ratio. The predefined ratio may be based on weight or volume. For example, the build container may be placed on the load cell 116 of the dosing section and dosing is carried out based on predetermined weights measured by the load cell and as determined by the controller 140.

At block 370, upon generating the dosed volume, a new build material ID identifying at least said reused build material, and optionally said dosed build material ratio, and/or one or more source IDs, are written to the tag 36 of said build container 30. The one or more source IDs may comprise one or more intended 3D printer IDs identifying one or more 3D printers for which the dosed volume is intended, and/or the post processing station ID that generated the dosed volume and/or to which the next build volume generated by the intended 3D printer is to be returned.

Thus, contamination of dosed volumes with build material mistakenly introduced into the post processing station may be prevented and quality of parts may be assured. Contamination may include use of different types of build material, where a build material type may include a build material name, batch number and/or a specific build material ratio of reused and fresh build material, and/or a reuse cycle range of the unfused build material and/or a temperature exposure range of the unfused build material in the 3D printer.

FIG. 4 is a schematic cross section front view through a 3D printer 20 configured to generate build volumes 38 comprising 3D objects 2 and unfused build material 4 to be provided in a build container 30 having an electronic tag 36. The 3D printer may be configured to write at least one of a build material ID and a source ID to the electronic tag 36 of the build container 30 comprising the build volume 38 before the build volume 38 is transferred to the post processing station. FIG. 4 illustrates a completed build volume 38 comprising objects 2 and unfused build material 4. The completed build volume is held within or is transferred into the build container 30 and the printer controller 240 controls a writer to write to the electronic tag 36 at least one of the source ID and/or the build material ID corresponding to that of the build material in the build material tank 220. The writer may further write build process data used to form the build volume, for example thermal data and/or an update of the number of cycles the unfused build material has passed through the 3D printer. Examples of such data are shown further below in Table 2. The 3D printer 20 comprises a build material tank 220 coupled to a dosing chamber 250 configured to provide an amount of build material to a work surface 210 for each layer before a distributor 260 passes over the work surface. The distributor 260, here in the form of a roller, spreads the dosed build material over a build volume supported on a piston 216 to form a new layer having a build area 212. The build material tank 220 may be a mixing tank configured to mix the dosed volume supplied to it from the build container; alternatively, the dosing section 120 may comprise a mixing means to mix the reused and fresh build material portions to a homogeneous mixture. The 3D printer may comprise means to selectively fuse build material to form the one or more objects 2, such as one or more lasers, or one or more printheads selectively depositing radiation absorbing ink and a heat source.

To manage the complete cycle of controlling build material flow through the additive manufacturing system, the 3D printer may comprise an electronic reader 242 coupled to a printer controller 240 to read the electronic tag 36 of the build container. When a build container 30 comprising an electronic tag 36 and a dosed volume is provided to refill the tank 220 of the 3D printer, the printer controller 240 may be configured to verify the build material ID and/or the source ID provided on the tag by the post processing station, before allowing the build material to be released from the build container 30 into the supply tank 220, for example in the manner as described with reference to FIG. 1. The printer controller 240 may be configured to store the one or more obtained IDs on a printer data storage device 74 internal to the printer or on a remote database, and to delete the data on the electronic tag 36. The build volume 38 may be generated directly in the build container 30, or it may be transferred to the build container 30 upon being completed. The printer controller 240 is configured to write the stored data, where necessary updated stored data, to the electronic tag 36.

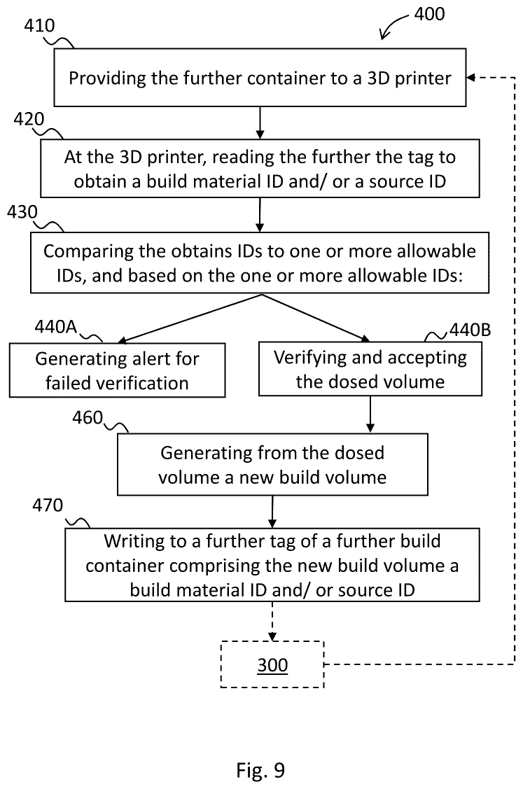

FIG. 9 illustrates corresponding further method steps 400 as carried out at the 3D printer following on from the method of FIG. 2 as carried out at the post processing station, the steps 400 comprising:
At block 410, providing the dosed volume in said build container 30 to a 3D printer. The 3D printer may be a single 3D printer or one of several 3D printers associated with the post processing station, or with several post processing stations;
At block 420, electronically reading at said 3D printer the electronic tag of said build container;
At block 430, comparing the new build material ID and the source ID as written to the tag by the post processing station at block 370 to the one or more allowable build material IDs and/or one or more allowable source IDs stored on a printer validation data storage device 74 comprised within or accessible by said 3D printer; and either:
At block 440A, upon determining that the obtained build material ID and/or the obtained source ID is not one of an allowable ID, generating an alert indicating that the dosed volume cannot be verified; or,
At block 440B, upon determining that the obtained build material ID and/or the obtained source ID is one of an allowable ID, accepting the dosed volume into the 3D printer for generating a new build volume. Optionally, at said 3D printer, upon receiving the dosed volume, the printer controller 240 may cause storing the at least one new build material ID, and optionally storing the source ID comprising the post processing station ID as obtained from the electronic tag. The source ID and/or new build material ID may be stored at a printer data storage device 74 that may be internal to or remote from but accessible via a network to the 3D printer.

Next, at block 460, the method may comprise generating and providing within a further build container the further build volume comprising 3D objects and unfused build material; and
At block 470, writing to the electronic tag of the or a further build container a further build material ID identifying the unfused build material and/or a further source ID comprising at least one of a 3D printer ID identifying said 3D printer and a post processing station ID identifying the or a further post processing station for which the new build volume is intended.

The method may then cycle back to method 300, by providing the further build volume to the or the further post processing station at block 310 of FIG. 2; at block 320 and 330 of determining whether the new build material ID and/or the source ID is an allowable build material ID and/or an allowable source ID; and, at block 340A, generating an alert indicating that the new build volume (or the unfused build material within the new build volume) cannot be verified, or is not allowable, based upon determining that the new build material ID and/or the source ID is not allowable; or at block 340B, releasing the new build volume into the post processing station based upon determining that the new build material ID and/or the source ID is allowable.

In summary, control over the flow of build material into the post processing station may be achieved by restricting the flow to a flow between verifiable system components only. The method may comprise a cycle of steps of:
At the post processing station, (i) receiving a build container, (ii) electronically reading the electronic tag and thereby obtaining a build material ID and/or a source ID stored thereon or linked thereto, and, if the obtained build material ID and/or the obtained source ID is an allowable ID, (iii) releasing the build volume into the post processing station; (iv) recovering unfused build material from the build volume; (v) generating a dosed volume of a first amount of unfused build material and a second amount of fresh build material, the first and second amount defining a ratio of reused to fresh build material; and (vi) writing to the electronic tag, or to a data storage device to which the tag provides a link, one of a new source ID and a new build material ID.

At the 3D printer, (i) receiving the dosed volume within the build container; (ii) electronically reading the electronic tag on the container and thereby obtaining the new source ID and/or new build material ID stored thereon or linked thereto; (iii) comparing the one or more obtained IDs to one or more allowable build material IDs and/or one or more allowable source IDs; and, if the obtained one or more IDs is one of said allowable IDs, (iv) accepting the dosed volume into the 3D printer; (v) generating a further build volume; (vi) holding, or transferring, the further build volume in the or a different build container comprising an electronic tag; and (vii) writing to the electronic tag, or to the data storage device to which the tag provides a link, a further source ID identifying at least one of the 3D printer, the build container, and the post processing station for which the further build volume is intended, and a further build material ID identifying at least the unfused build material in the further build volume. The cycle of steps is then repeated one or more times.

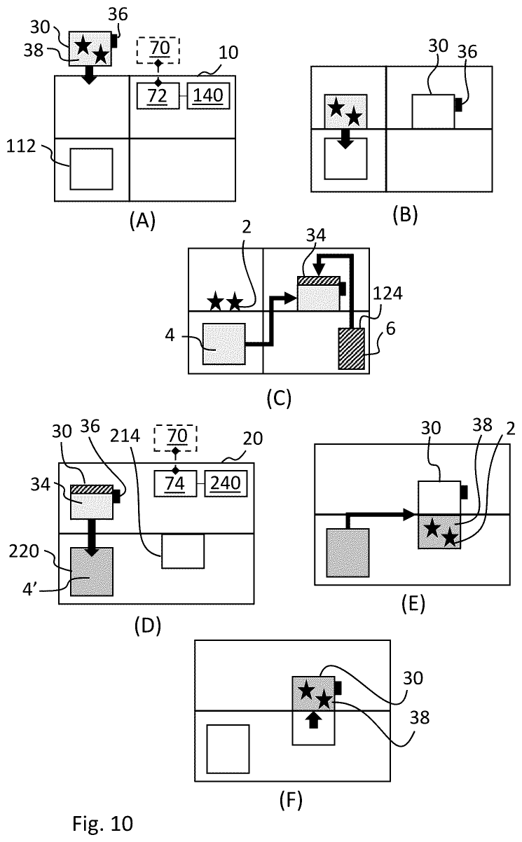

This is illustrated in more detail in FIG. 10(A)-(F), which is a variant of FIG. 1 illustrating the different stages of flow of build material, and in which repeated labels to the same component are omitted. FIG. 10(A)-(C) schematically depict the flow through a post processing station 10, and FIG. 10(D)-(F) schematically depict the continuing flow through a 3D printer 20. Starting with FIG. 10(A), a build container 30 comprising an electronic tag 36 and a build volume 38 comprising objects is provided to the post processing station 10. The controller 140 compares the one or more build material ID and source ID to one or more allowable build material IDs and one or more allowable source IDs, and upon determining that the one or more stored ID correspond to one or more respective allowable IDs, accepts the build volume 38 into the depowdering section of the station. Next, the build volume is processed and unfused build material 4 is recovered and transferred to the recovery hopper 112. This is shown in FIG. 10(B). A build container 30 is provided to the dosing section of the station. Optionally, the controller may verify the container as an allowable container as described herein based on the source ID stored on the tag. FIG. 10(C) illustrates the separated objects 2 and unfused build material 4, and the step of dosing a dosed volume 34 to the build container 30 to a predefined ratio of reused build material 4 from the hopper 112 and fresh build material 6 from the supply container 124. Upon completing the dosed volume 34, the controller 140 causes a new source ID and new build material ID to be written to the tag. The source ID may comprise a 3D printer ID for which the dosed volume 34 is intended. The validation data storage device and/or the data storage device of the post processing station may be comprised in an internal storage device 72 and/or in part on a remote database 70.

Turning next to FIGS. 10(D)-(F), FIG. 10(D) illustrates the dosed volume 34 in the build container 30 being provided to the 3D printer 20. The printer controller 240 compares the build material ID and/or source ID written to the tag to one or more allowable build material IDs and/or one or more allowable source IDs, and upon determining that the one or more stored IDs correspond to one or more respective allowable IDs, accepts the dosed volume 34 into the tank 220 of the 3D printer. The printer validation data storage device and/or the printer data storage device of the 3D printer may be comprised in an internal storage device 74 and/or in part on the same or a remote database 70. For example, the IDs may be stored on a remote database 70 shared between the post processing station 10 and the 3D printer 20, and the allowable IDs may be stored on the respective internal memory 72 of the post processing station and the printer internal memory 74. Next, as illustrated in FIG. 10(E), the dosed volume is processed and a further build volume 38 comprising objects 2 and unfused build material 4′ is generated by the 3D printer. Next, the printer controller 240 causes a further source ID and/or build material ID to be written to the tag, and the build volume is provided to the post processing station to repeat the cycle illustrated in FIGS. 10(A)-(F). FIG. 10(F) illustrates the build volume 38 being ejected into a build container 30, which may be the same or a different build container. Optionally, the printer controller 240 may verify the build container to be an allowable build container based on a source ID stored on its tag 36.

The 3D printer receiving the new dosed volume may be the same 3D printer that generated the build volume, or it may be a different printer of a plurality of verifiable 3D printers associated with the post processing station. Furthermore, a plurality of post processing stations may be associated with a plurality of 3D printers and between which the dosed volumes and build volumes are shared. Control of build material flow may be ensured where the 3D printers, build containers and post processing stations forming the additive manufacturing system are set up to process build material of the same type. The same material type may be material of the same name (e.g. PA12, PA11) and the same composition provided in a plurality of batches with a predefined batch variation. Optionally, the dosed volume may be of substantially the same ratio of reused to fresh material. Optionally, the number of cycles over which unfused material may be reused may be predefined. Optionally, the batch number may be the same. The level of control of the build material allowed to enter the post processing station to be reused for a further dosed volume may be determined based on the specific material and the intended part properties, and/or based on the batch variability of fresh material for example.

FIG. 1 illustrates an additive manufacturing system comprising a post processing station 10 and a single 3D printer 20, and further two build containers to transfer build volumes and dosed volumes between the 3D printer 20 and the post process station 10. The post processing station may thus be configured to receive one or more build containers, each build container comprising a corresponding electronic tag. The electronic tag 36_1, 36_2 of each build container 30_1, 30_2 may store, and may permanently store, thereupon a source ID comprising at least one of a build container ID identifying said build container and a single 3D printer ID, and wherein the validation data storage device of the post processing station stores the build container ID and/or the 3D printer ID as an allowable ID, and optionally wherein the printer validation storage device stores the build container ID and/or the 3D printer ID as an allowable ID.

Systems with Multiple 3D Printers

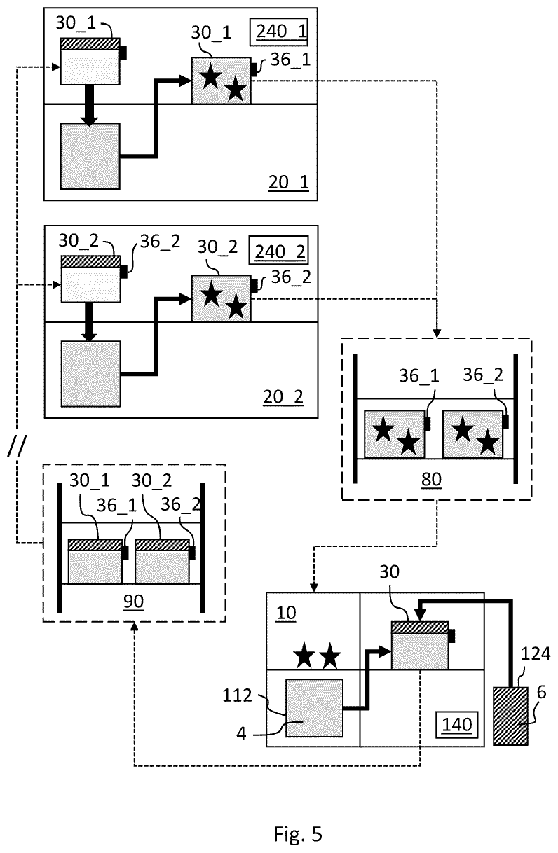

FIG. 5 is a variant of FIG. 1, illustrating an additive manufacturing system comprising two 3D printers 20_1, 20_2 associated with one post processing station 10 and in which two build containers 30_1, 30_2 may be shared between the two 3D printers, such that the first build container 36_1 and the second build container 36_2 may be verifiable for use with the first 3D printer 20_1 and the second 3D printer 20_2.

In other examples, however, the electronic tag 36_1 may store ID data that identifies the first container 30_1 as verifiable only on the first 3D printer. This may be beneficial for example where the first 3D printer processes the dosed volume at a higher temperature than the second 3D printer, and thus the unfused build material comprised within the resulting build volume may require different post processing. For example, the unfused build material from the first 3D printer may age more than the unfused build material from the second 3D printer. Thus the unfused build material with the higher thermal history may be identified by the build container ID or the 3D printer ID. More than one build container may be provided per 3D printer for effective throughput of successive build volumes, and which may be stored in intermediate cooling stations after a completed build volume.

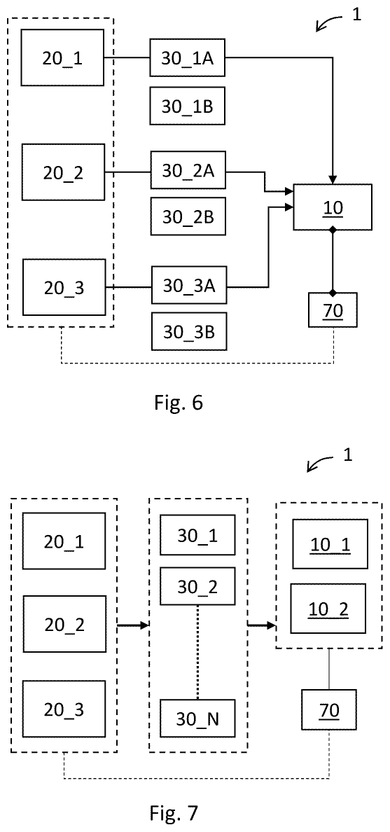

This is illustrated in FIG. 6, which is a simplified block diagram of material flow through an additive manufacturing system 1 comprising three 3D printers 20_1, 20_2 and 20_3, each associated with a set of two build containers 30_nA and 30_nB. For example, the one or more build containers of each set may be identifiable by their build container ID and/or the 3D printer ID of their associated 3D printer, permanently stored on the electronic tag of each build container. The build volume and/or the dosed volume may be verified based on the build container ID and/or 3D printer ID being determined as an allowable build container ID. To allow control of the flow of build material, the electronic tag of the one or more of the build containers 30_nA, 30_nB may store, and may permanently store, the 3D printer ID of at least one of the one or more 3D printers 20_n and/or the build container ID identifying said build container 30_nA, 30_nB, and wherein the validation data storage device of the post processing station and the printer validation storage device of the 3D printer store said 3D printer IDs and/or source IDs as allowable 3D printer IDs and/or as allowable source IDs. Furthermore, the electronic tag of each build container may store, and may permanently store, the 3D printer ID of a single one of a plurality of 3D printers, and the validation data storage device of the post processing station may store said single 3D printer ID as allowable 3D printer ID and the printer validation storage device of the 3D printer stores said 3D printer IDs as a single allowable 3D printer ID. Thus the post processing station 10 may accept multiple build containers from multiple printers 20_1, 20_2, 20_3 but each 3D printer can only accept dosed volumes from a single post processing station 10 as a result of the obtained single 3D printer ID.

For this purpose, the controller 140 of the post processing station 10 may be configured to verify each build container at the dosing section so as to dose a dosed volume into a container corresponding to the respective 3D printer. For example, the controller may be configured to dose a dosed volume into one of the first set of build containers 30_1A, 30_1B after verifying that the 3D printer ID stored on the tag is that of the first 3D printer. A build container from the second set may be rejected for dosing a dosed volume intended for the first printer. Thus, upon providing a build container to the dosing section of the post processing station, the controller may be configured to obtain the build container ID and/or 3D printer ID from the electronic tag of the or the further build container, and determine, by comparing the build container ID with the one or more stored allowable build container IDs and/or allowable 3D printer ID, whether the obtained build container ID and/or the obtained 3D printer ID corresponds to one of the allowable build container IDs and/or the allowable 3D printer ID; and, upon determining that the obtained build container ID and/or the obtained 3D printer ID does not correspond to one of said allowable IDs, generate an alert that the build container or its ID cannot be verified. This may avoid contamination by residues left in the build container when it is used by a different system processing a different build material.

The same 3D printer ID may be stored, preferably permanently, on the electronic tag of a plurality of build containers associated with the same 3D printer, e.g. the first set of build containers 30_1A and 30_1B may store the ID of the first 3D printer 20_1, and the second set of build containers 30_2A and 30_2B may store the ID of the second 3D printer 20_2, and so on. The controller of the post processing station 10 is configured to verify a plurality of build containers having the same 3D printer ID. In addition, increased build material control may be achieved for a particular 3D printer when the unfused build material from the first 3D printer is only used to dose a new dosed volume for the first 3D printer and not for the second 3D printer, and so on. Thus new dosed volumes may be prepared until the unfused build material from a previous build has been reused fully, and the hopper of the recovery section is empty, before accepting a new build volume from a different 3D printer. This allows tighter control by simplified tracing over the build material history since different build volumes of potentially different histories are not mixed in the recovery section.

Systems with Multiple 3D Printers and Multiple Post Processing Stations

FIG. 7, which is a variant of FIG. 6, illustrates a variant according to the invention described herein in which a plurality of build containers 30_1, 30_2, . . . 30_N may be shared between a plurality of 3D printers, here three 3D printers 20_1, 20_2 and 20_3. Furthermore, FIG. 7 illustrates an additive manufacturing system in which two post processing stations 10_1 and 10_2 are provided, each comprising a controller configured to verify each shared build container 30_N as an allowable build container. The validation data storage device thus stores a plurality of allowable source IDs that correspond to the build container ID of each build container 30_1 to 30_N and/or to the 3D printer ID of each 3D printer 20_1, 20_2, 20_3. The source IDs may be stored permanently on each container, such that the electronic tag of each container comprises a source ID comprising a build container ID and a plurality of 3D printer IDs (which in the case of FIG. 7 is three 3D printer IDs identifying the three 3D printers 20_1, 20_2, 20_3 of the system as allowable 3D printers. Optionally, the source ID may comprise the ID of the post processing stations and each 3D printer validation data storage device 74 may store the plurality of allowable source IDs that correspond to the build container ID of each build container 30_1 to 30_N and/or to the post processing station ID of each post processing station 10_1, 10_2. In this way each printer controller may be configured to verify each dosed volume as an allowable dosed volume if the obtained build container ID and/or the obtained post processing station ID corresponds to an allowable build container ID and/or an allowable post processing station ID. In this system, each 3D printer and post processing station is configured to process the same type of build material, and the controller of each post processing station of the system may be configured to recognise each of the 3D printers by their individual printer ID, for example, or alternatively verify a build volume by its own post processing station ID as provided by a 3D printer of the system. In turn, the printer controller of each 3D printer of the system may be configured to recognise each of the post processing stations by their individual post processing station ID, or alternatively by its 3D printer ID as provided by a post processing station of the additive manufacturing system.

In an additive manufacturing system described herein, comprising a post processing station as described herein, one or more build containers, and one or more 3D printers, wherein each build container comprises an electronic tag, and wherein each 3D printer is configured to generate a build volume comprising one or more 3D objects and unfused build material, control of build material flow may be enhanced or provided by each 3D printer being configured to write to the electronic tag of a respective build container holding a build volume generated by the respective 3D printer: (a) a source ID that comprises a 3D printer ID that identifies said 3D printer, and/or a post processing station ID identifying the post processing station for which the build volume is intended, and (b) a build material ID that identifies the unfused build material of the build volume. Alternatively, the 3D printer may be configured to write to the electronic tag a link to said IDs stored on a data storage device accessible by the post processing station via a network. The build material ID may identify at least one of a build material name, and optionally one or more of a ratio of reused to fresh build material within the unfused build material of the build volume, a fresh build material batch number, and a reuse history. In order to control or restrict the acceptance of unfused build material into the post processing station 10, the validation data storage device of the post processing station may store a single allowable build material ID identifying a predefined allowable build material name, and optionally identifying one or more of a predefined allowable ratio of reused to fresh build material within the unfused build material, an allowable fresh build material batch number, and an allowable number of reuse cycles.

The 3D printer, or a hub of 3D printers, may be configured to accept only dosed volumes that can be identified as being of a single material type. Therefore, wherein the build material ID identifies at least a build material name, and optionally one or more of a ratio of reused to fresh build material within the dosed volume, the batch number of the fresh material, and the number of reuse cycles; and the post processing station may be configured to generate successive dosed volumes identifiable by the same predefined allowable build material name, and by optionally one or more of the same predefined allowable ratio of reused to fresh build material, the allowable build material batch number of fresh build material dosed, and within an allowable number of reuse cycles, the reused material originating from unfused build material of the same build material name and ratio of reused to fresh build material. The controller of the post processing station is further configured to write to the electronic tag of the respective build container holding the dosed volume: a build material ID identifying the build material name, and optionally one or more of the dosed ratio of reused to fresh build material, a fresh build material batch number, and the number of reuse cycles; and to write a source ID, identifying at least one of the plurality of 3D printers and/or said post processing station that generated the dosed volume; or a link to build material and source ID stored on the or a further data storage device.

Each 3D printer of the system may comprise a printer controller having a printer electronic tag reader in communication with a printer validation data storage device, wherein the printer validation data storage device comprises the allowable build material ID and/or the allowable source ID; wherein the printer controller is configured to: (a) read the electronic tag and thereby obtain the build material ID and/or source ID stored thereon or linked thereto; (b) determine whether the obtained build material ID and/or the obtained source ID corresponds to the allowable build material IDs and/or the allowable source ID, by comparing the obtained build material ID and/or the obtained source ID with said stored allowable build material ID and/or said stored allowable source ID; and: (b1) upon determining that the obtained build material ID and/or the obtained source ID does not correspond to the allowable build material ID and/or the allowable source IDs, generate an alert that the obtained build material ID and/or the obtained source ID cannot be verified; or (b2) upon determining that the obtained build material ID and/or the obtained source ID corresponds to the allowable build material IDs and/or to the allowable source IDs, accepting the dosed volume into the 3D printer for generating a further build volume.

The additive manufacturing system, post processing station and 3D printer with associated build containers comprising an electronic tag each and methods of use according to the invention disclosed herein thus ensure that a post processing station may only accept a predefined build material, and optionally that the 3D printer only accepts a dosed volume from one or more predefined post processing stations. The system is thus configured to only allow build material flow of the same type of build material. This avoids contamination and potential reduction in part quality or failure of a build process due to erroneously loading the wrong type of build material into the post processing station, and as a result, dosing the wrong type of reuse material with fresh build material in the dosing section. The “wrong type” of build material may comprise a different reuse to fresh material ratio despite having the same material name, since ageing of material can cause significant departure from the expected properties, such as from the melting temperature.

### Multiple Additive Manufacturing Systems

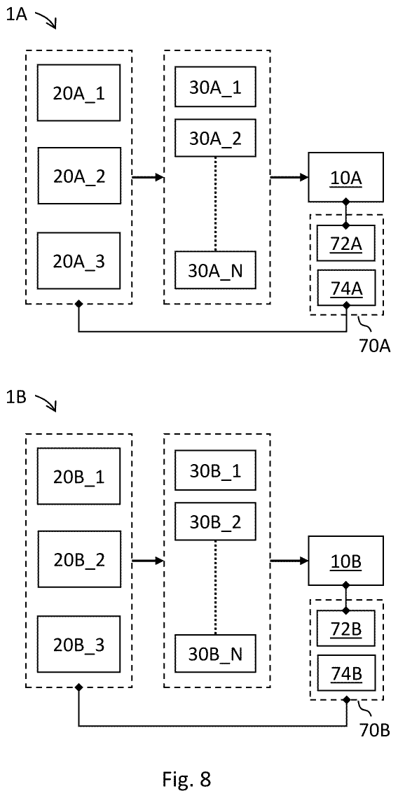

An industrial manufacturing site may comprise a plurality of additive manufacturing systems, comprising a 3D printer hub processing different build materials and one or more post processing stations. FIG. 8 is a block diagram illustrating controlled build material flows through two distinct additive manufacturing systems 1A and 1B. The first system 1A comprises a first post processing station 10A associated with three 3D printers 20A_1, 20A_2, and 20A_3 which share a plurality of build containers 30A_1, 30A_2 . . . , 30A_N between them. The controller of the first post processing station 10A is configured to verify only those build containers 30A_1, 30A_2, . . . , 30A_N as allowable based on the source ID stored on each of their electronic tags. A second system 1B comprises a second post processing station 10B associated with a further three 3D printers 20B_1, 20B_2 and 20B_3 which share a plurality of build containers 30B_1, 30B_2, . . . , 30B_N. The controller of the second post processing station 10B is configured to verify only those build containers 30B_1, 30B_2, . . . , 30B_N of the second system 1B as allowable based on the source ID stored on each of their electronic tags. The data validation storage device 72A of the first post processing station 10A thus stores only a set of allowable source IDs that correspond to the source IDs of the first system, i.e. the 3D printer ID for the 3D printers 20A_1, 20A_2, and 20A_3 of the first system and/or the build container IDs of the build containers 30A_1, 30A_2, . . . , 30A_N of the first system. The data validation storage device 72B of the second post processing station 10B meanwhile stores only a set of allowable source IDs that correspond to the source IDs of the second system, i.e. the 3D printer ID for the 3D printers 20B_1, 20B_2, and 20B_3 of the second system and/or the build container IDs of the build containers 30B_1, 30B_2, . . . , 30B_N of the second system. The description of the system and its components of FIG. 7 applies equally to each system 1A, 1B of FIG. 8.

When a build container 30B_N of the second additive manufacturing system 1B is provided to the first post processing station 10_1 of the first system 1A, the controller of the first post processing station is configured to obtain from the electronic tag the source ID in the form of the plurality of 3D printer IDs and/or the build container ID and compare them to the allowable IDs associated with the first system stored on the validation data storage device 72A of the first post professing station 10A. The controller of the first post professing station 10A determines that the build volume in the build container 30B_N of the second additive manufacturing system 1B cannot be verified, and provides an alert to the user. Furthermore, the controller may control the depowdering section of the first post processing station 10_1 to refuse accepting a build volume from the build container of the second system. Thus the release of the wrong unfused build material into the post processing station is prevented, and contamination of build material for supply back to a 3D printer of the first system is avoided. Additionally, or instead, the source ID may comprise the identification IDs for the post processing station and the one or more 3D printers of the same system. This allows a specific build container to be verified at the post processing station and optionally the one or more 3D printers as being part of the system. This may prevent accidentally introducing a build container of a different system, for example accidentally providing a build container 30_1, 30_2 of the first system 1A to the post processing station 102 of the second system 1B.

Upon verifying an allowable dosed volume, the printer controller 240 of the 3D printer may erase some data from the tag 36. The build container ID may be permanently stored on the tag such that the container is always identifiable by its unique build container ID. The controller may further be configured to allow the reused and fresh build volume only to be dosed to an allowable container upon determining that the build material ID of the container 30 comprises an allowable container ID. For this purpose, the dosing section 120 may comprise an electronic reader configured to read the electronic tag on the container 30 before initiating a dosing action, and initiating the dosing action only upon verifying that the build material ID represents an allowable build container ID. Furthermore, the controller 240 of the or several 3D printers 20 may be configured to verify the build container ID stored on the tag, and to only allow a dosed volume 34 from a verifiable build container 30. In this way, the build material flow may be controlled more tightly, thus avoiding accidental contamination of residues of build material due to use of build containers with different, unallowable material types.

For each system therefore, the controller 140 of each post processing station is configured to verify the build volume provided based on the individual obtained IDs of each of the three 3D printers 20_1, 20_2, 20_3. The electronic tag of each build container 30 may thus store a single one of a plurality of 3D printer IDs, wherein each 3D printer ID corresponds to a different 3D printer, and/or a single one of a plurality of build container IDs, wherein each build container ID corresponds to a different build container. The validation data storage device stores a plurality of allowable 3D printer IDs corresponding to the plurality of 3D printer IDs and/or the plurality of allowable build container IDs corresponding to the plurality of build container IDs. In this way, the flow of build material from several 3D printers 20_n into the post processing station 10 may be controlled by applying the verification by the controller 140 as described herein, and optionally furthermore the verification by the 3D printer controllers 2401, 240_2, and releasing an unverified build volume into the post processing station may be prevented. Thus it may be ensured that only the same material type is loaded into the post processing station 10, and only the same material type is cycled through the additive manufacturing system. In addition, the unfused build material may be identified and verified by its build material ID.

### Build Containers and Build Material ID

By providing a plurality of build containers for the system, build volumes may be allowed within one build container, e.g. in a cooling station 80, before being loaded into the breakout section 110 of the post processing station 10. The build containers may for this purpose comprise heating means such as foils and connectivity to a power supply to enable a controlled cool down of the build volume. Meanwhile, a next build process may be started and a new build volume provided to a second build container. The same one or more containers may be provided to hold the build volume and to hold the dosed volume, although this is not necessary. One or more build containers may be used to transfer the build volume from the 3D printer to the post processing station, and a different one or more build containers may be used to transfer the. For example, the build containers used to transfer dosed volumes from the post processing station to the 3D printer(s) may not comprise heating means for controlled cooling. The build container may be a component separate to the 3D printer that the build volume is transferred into after the build volume has been generated. Alternatively, the build volume may have been formed within a build container that may be removed from the 3D printer and that is connectable to the post processing station. The build container may be part of a transfer module comprising further components to the build container and electronic tag. A transfer module may further comprise the supply tank 220 and which may be refilled directly at the post processing station as described herein. The transfer module may thus comprise the electronic tag as described herein.

The build material ID may comprise identification of one or more of a ratio of reused to fresh build material within the unfused build material; a batch number of the fresh build material; a reuse indicator of the unfused material in the build volume, a reuse history of the reused build material in the dosed volume; a build material name of the fresh build material and/or the reused build material; and a melting temperature of the unfused build material as determined by the 3D printer from which the build volume originates. The build material ID may allow determination that the expected build material type is being loaded into the post processing machine to avoid contamination with the wrong type of build material. The build material type may comprise a build material identification, to identify at least the build material name, and optionally the ratio of reused to fresh build material that was provided to the additive manufacturing apparatus. In addition, a use history of the reused build material may be logged on the electronic reader by the additive manufacturing apparatus. In this way, at the post processing station, the build material ID may further allow the controller to determine that an unfused amount of build material recovered from the build volume has exceeded an allowable reuse rate, and that it should not be used for refilling the build container for loading into a corresponding additive manufacturing apparatus. The controller may generate an alert to the user that the unfused amount should be discarded upon determining, based on the build material ID, that the unfused build material has exceeded an allowable reuse rate, comprises contamination with for example printhead liquid or foreign objects or particles, or has experienced excessive ageing. For example, the apparatus may be configured to provide thermal data to the tag to allow the controller at the post processing station to determine that a temperature threshold was exceeded during the build process in the additive manufacturing apparatus, and to alert the user that the recovered unfused amount should be discarded. Details of the build material may be stored on a server or database and the build material ID identifies the storage location. At the post processing station, upon obtaining the build material ID and any corresponding history that may flag that the unfused build material should not be reused, the controller may issue instructions that allow the build volume to be depowdered but the recovery hopper is to be purged and the recovered unfused build material discarded. A determination that unfused build material may be compromised based on data in the build history may be made manually by the user who may enter a flag to the specific build job. The flag information may be included in the build material ID, or stored on a database from where it may be retrieved, for example as part of the build material ID. Optionally, the build material history, comprising for example number of reuse cycles and thermal information, may be analysed by an artificial intelligence system to generate a flag that the unfused build material should be rejected. At the post processing station, upon the controller 140 comparing the obtained IDs with the allowable IDs, the obtained build material ID comprises or provides a link to the flag to be retrieved by the controller 140. Based on the information on the flag, the controller 140 may generate an alert that the obtained build material ID is not an allowable ID, which may comprise issuing manual or automatic instructions that the build volume is refused from entering the depowdering section, or, after depowdering the objects from the unverified unfused build material, that the unverified unfused material is to be purged from the recovery hopper and is not to be used for generating a new dosed volume. Optionally, the controller 140 may be configured to prevent the unverified unfused build material from entering the dosing section.

The build material may be provided in bags with a batch number. When filling fresh powder into an empty supply tank of the post processing machine, the batch number may be registered on the memory of the controller of the post processing station.

Preferably, when a build container has been filled with a dosed volume at the post processing station, the recovery hopper may be emptied of all remaining unfused build material to avoid mixing with a different build volume of unfused build material. In this way it is possible to trace and verify which powders are contained in certain build volume. In one example, after dosing reused and fresh build material to the build container in the dosing section of the post processing station, the controller may cause the following information to be written to the electronic tag of the build container: a time stamp; the weight and the batch TD of fresh build material; and the weight of reused powder and the printer ID of the printer the reused (unfused) powder originated from. Other data may be written to the tag, for example powder type like PA11 or PA12.

The two tables below specify read and write instructions to an electronic tag of a build container as an example of the data flow on the tag when moving between one or more post processing stations and one or more 3D printers. The flow of data may apply to any of the embodiments and their variants described herein; with the option of permanently storing for example the 3D printer ID and the post processing station TD (“PPS ID” in the tables) on the tag depending on the level of restriction applied within the system.

TABLE 1
Data flow on an electronic tag at the post processing station

| | depowdering | | | |
|---|---|---|---|---|
| | section | | dosing section | |
| | Read | Write | Read | Write |
| build container ID | yes | | yes | |
| Build ID | yes | reset | | reset |
| 3D printer ID | yes | | | reset |
| timestamp | yes | reset | | |
| Build volume height | yes | reset | | reset |
| # of objects | yes | reset | | reset |
| build density | yes | reset | | reset |
| reuse history | yes | reset | | <updated history> |
| # of reuse cycles | yes | reset | | <updated cycles> |
| Build material ID | | | | <material ID> |
| Material type | yes | reset | | <material type dosed> |
| Fresh batch number | | reset | | <fresh material batch |
| | | | | number> |
| Fresh material mass | | reset | | <mass of fresh powder |
| | | | | dosed> |
| Reuse material mass | | reset | | <mass of reused material |
| | | | | dosed > |
| Target ratio | | | yes | reset |
| dosed ratio | | | | <% of dosed fresh |
| | | | | material> |
| PPS ID | yes | reset | | <PPS ID> |
| PPS instructions | yes | reset | | reset |

Table 1 shows read and write instructions for the tag at the post processing machine. The first set of read:write columns relate to read and write actions as carried out by the controller of the post processing station when a build container is received at the depowdering section for verification, for example at the step shown in FIG. 10(A). The second set of read:write columns relate to read and write actions as carried out by the controller 140 when verifying and receiving a build container 30 for dosing a dosed volume to, for example at the step shown in FIG. 10(C).

Table 2 shows read and write instructions for the tag at the 3D printer. The first set of read:write columns relate to read and write actions as carried out by the printer controller 240 of the 3D printer 20 when a build container 30 is received, for example at the step shown in FIG. 10(D). The second set of read:write columns relate to read and write actions as carried out by the controller 240 when writing to the electronic tag of the build container 30 holding the completed build volume 38, for example at the step shown in FIG. 10(F).

TABLE 2
Data flow on an electronic tag at the 3D printer

| | Dosed volume | | | |
|---|---|---|---|---|
| | verified | | Build volume complete | |
| | Read | Write | Read | Write |
| build container ID | Yes | | Yes | |
| build_ID | | | | <build ID> |
| 3D printer ID | yes | reset | | <3D printer ID> |
| timestamp | | | | <time build completed> |
| Build volume height | | | | <build volume height> |
| # of objects | | | | <# of objects in build |
| | | | | volume> |
| build density | | | | <build density> |
| reuse history | yes | reset | | <updated history> |
| # of reuse cycles | yes | reset | | <updated # cycles> |
| Build material ID | yes | reset | | <material ID in 3D |
| | | | | printer> |
| Material type | yes | Reset | | <material type in 3D |
| | | | | printer> |
| Fresh batch number | yes | Reset | | |
| Fresh material mass | yes | Reset | | |
| Reuse material mass | yes | reset | | |
| Target ratio | | | | <target ratio for |
| | | | | system> |
| dosed ratio | yes | Reset | | |
| PPS ID | yes | reset | | <intended PPS ID> |
| PPS instructions | | | | <depowdering |
| | | | | instructions> |

In the Tables, the build material ID that may comprise information to identify one or more of the material type, the batch number of fresh build material used to generate the dosed volume, the mass of the fresh material and of the reused material and the resulting ratio. Instead of mass, a volume maybe used. Thus only the build material ID may be provided on the tag. The target ratio may optionally be provided to the electronic tag of the build container by the printer controller 240 at the step of FIG. 10(F) before the build volume is removed from the 3D printer. In this way the printer controller may ensure that the build container is refilled with the target ratio. The post processing station may read the target ratio and ensure that the correct ratio is dosed at the dosing section at FIG. 10(C) for supply to the 3D printer. The build job provided to the 3D printer may include instructions (“PSS instructions”) for use at the post processing machine that may alert the user to the location of sensitive or fragile objects or defines a specific depowdering routine. Such information may be stored or provided via a link as identified by a “build ID” written to the electronic tag at the 3D printer.

When a build container arrives at the 3D printer, the printer controller reads the electronic tag and may store read data. The controller may then cause electronic tag to be reset and some or all of the data to be erased. The 3D printer may maintain a history of the data read from the tag, and a user may retrieve the data to ascertain, for example: which 3D printer(s) or build volumes comprise build material from a certain fresh build material batch; whether build material from other 3D printers entered said 3D printer, or which other 3D printers and build volumes may have received build material processed by a specific 3D printer. Further traceability may be provided by emptying the supply tank of the 3D printer before refilling it with build material from the build container.

The allowable IDs may be stored on an internal memory of the respective post processing station or 3D printer, or alternatively on one or more servers representing the validation data storage device, accessible via a network by the controller of the one or more post processing stations and/or the printer controller of the one or more 3D printers of each system. Where the tag comprises a link to the one or more IDs stored on a database or server, the controller or printer controller may access the one or more IDs via a network or internal link. For example, the IDs may be stored on a remote server or database 70. The data storage device 72 of each of the post processing stations and the data storage device 74 of each 3D printer storing for example the unique ID of that station or printer, and temporarily storing data read on the electronic tag of a build container may be an internal memory of that post processing stations or 3D printer, or it may be comprised within the one or more servers representing the validation data storage device as indicated by storage device 70. Any of the IDs described herein may be provided to the tag in the form of a link to a storage device storing said IDs, accessible by the controller of a post processing stations and/or the printer controller of a 3D printers of a system via a network. A post processing station and an additive manufacturing system configured to provide a method of controlled build material flow as disclosed herein thus may reduce or prevent unintentional contamination by unverified build material entering a post processing machine, which may further contaminate a dosed volume provided to a 3D printer. Further provided is the ability to comprehensively trace and control the flow of reused and fresh build material, enabling part quality assurance for certified manufacturing, process and failure analysis, and professional service support by storing and using, as part of the build material ID, the history and/or reuse cycles of the unfused build material, the dosed powder ratio, and the build material properties described herein.

It is not necessary that each build container is identical in design and functionality, or that the build container and the further build container are identical in design and functionality. For example, the build container into which the dosed build volume is provided may be of a different design from that of the build container used to transport a build volume from the 3D printer to the post processing station. For instance, a build container used to transport the build volume from the 3D printer to the post processing station may comprise heating and/or cooling elements and be connectable to a power source for independently regulating the cooling rate of the build volume. The further build container may comprise mixing elements to mix the dosed build material and keep it in a free flowing state. The load cell may instead be any other sensor suitable to measure the amount of build material dosed to the build container or further build container. Other sensors may be capacitive sensors, for example.

### Other Implementations

In other implementations, the build volume comprising the 3D objects may be depowdered in a separate depowdering station and the unfused build material is transported to the post processing station in a build container or further build container having an electronic tag that has been provided by the depowdering station with the at least one source ID and build material ID. The post processing station comprises a receiving section and a dosing section and is configured to controllably and traceably receive the unfused build material based on the data on the electronic tag and dose it with fresh build material for reuse in further build processes. The system may in this case comprise two post processing stations, one configured to depowder and the other configured to dose, and each configured to read and write to the electronic tag of the build container at least one of a source ID and build material ID.

Accordingly, the present disclosure provides a post processing station for dosing unfused build material and fresh build material for reuse by a 3D printer, the post processing station comprising a receiving section and a dosing section, wherein the receiving section is configured to receive a build container comprising unfused build material, wherein the build container comprises an electronic tag storing at least one of a build material ID, and a source ID comprising one or more of a build container ID, a 3D printer ID and a post processing station ID, or a link to at least one of said IDs stored on a data storage device; wherein the post processing station comprises a controller having an electronic tag reader in communication with a validation data storage device, wherein the validation data storage device comprises one or more stored allowable build material IDs and/or one or more stored allowable source IDs; wherein the controller is configured to:
upon receiving the build container at the receiving section, read the electronic tag and thereby obtain the build material ID and/or source ID stored thereon or linked thereto;
determine whether the said one or more obtained IDs corresponds to one of the said allowable IDs, by comparing the said one or more obtained IDs with said one or more stored allowable IDs; and
upon determining that the obtained build material ID and/or the obtained source ID corresponds to one of said allowable IDs, accept the unfused build material into the receiving section for dosing, or
upon determining that the obtained build material ID and/or the obtained source ID does not correspond to one of said allowable IDs, generate an alert that the obtained build material ID and/or the obtained source ID cannot be verified.

The post processing station may be configured to receive a plurality of build containers, each comprising a corresponding electronic tag.

Each electronic tag may store a single one of a plurality of 3D printer IDs, each 3D printer ID corresponding to a different 3D printer, and/or a single one of a plurality of build container IDs, each build container ID corresponding to a different build container; and the validation data storage device may store a plurality of allowable 3D printer IDs corresponding to the plurality of 3D printer IDs and/or a plurality of allowable build container IDs corresponding to the plurality of build container IDs.

The same 3D printer ID may be stored on the electronic tag of two or more corresponding build containers.

Optionally the dosing section may comprise a fresh build material tank, and a load cell configured to support the build container or a further build container,
wherein the build container or the further build container is fluidically couplable to the receiving section and a fresh build material tank, respectively defining a reuse build material transport path and a fresh build material transport path;
wherein, upon the controller determining that the build material ID and/or the source ID of the build container is an allowable build material ID and/or an allowable source ID, the controller is further configured to control the post processing station to:
determine that the build container or the further build container is positioned on the load cell;
control the reuse build material transport path to transport unfused build material from the receiving section to the build container or to the further build container;
determine, based on a weight of unfused build material in the build container or in the further build container as detected by the load cell, an amount of fresh build material required to achieve a predetermined ratio of reuse build material to fresh build material;
control the fresh build material transport path to transport the determined amount of fresh build material into the build container or the further build container; and
   optionally, provide the electronic tag of the build container or of the further build container with at least one of a new build material ID and/or an intended 3D printer ID.

Optionally the receiving section may comprise a depowdering section and a recovery section, wherein the recovery section comprises a recovery tank,
wherein the depowdering section is configured to separate unfused build material from the one or more 3D objects, wherein the build container or the further build container is fluidically couplable to the recovery tank to define the reuse build material transport path;
wherein, upon the controller determining that the build material ID and/or the source ID received at the receiving section is an allowable build material ID and/or an allowable source ID, and before controlling the reuse build material transport path to transport unfused build material from the receiving section to the build container or to the further build container, the controller is configured to control the post processing station to:
release the build volume into the depowdering section; and
in the depowdering section, cause the build volume to be depowdered and the unfused build material to be transported from the depowdering section into the recovery tank.

Optionally, upon the controller determining that the build material ID and/or the source ID is not an allowable build material ID and/or an allowable source ID, the generated alert may comprise instructions to purge the recovery tank of recovered unfused build material after releasing of the build volume into a depowdering section and separating the one or more 3D objects from unfused build material; and optionally the controller may be configured to prevent the unfused build material from entering the dosing section.

Optionally the source ID may comprise a build container ID permanently stored on the electronic tag, wherein the validation data storage device comprises one or more stored allowable build container IDs, and upon providing the or a further build container to the dosing section of the post processing station, the controller is configured to obtain the build container ID from the electronic tag of the or the further build container, and determine, by comparing the build container ID with the one or more stored allowable build container IDs, whether the obtained build container ID corresponds to one of the allowable build container IDs; and, upon determining that the obtained build container ID does not correspond to one of the allowable build container IDs, generate an alert that the obtained build container ID cannot be verified.

Optionally the build material ID may identify one or more of a ratio of reused to fresh build material of the unfused build material; a batch number of the fresh build material; a reuse history of the reused build material; a build material name of the fresh build material and/or the reused build material; and a melting temperature of the unfused build material as determined by the 3D printer from which the build volume originates.

Also provided is an additive manufacturing system comprising a post processing station as described above, and one or more build containers, each build container for containing unfused build material recovered from a build volume from one or more 3D printers and comprising an electronic tag; wherein the electronic tag of each build container is configured to store at least one of:
a source ID that identifies at least one of the 3D printers or a link to said source ID stored on a data storage device;
a post processing station ID identifying the post processing station for which the unfused build material is intended, and
a build material ID that identifies the unfused build material or a link to said build material ID stored on the or a data storage device.

Optionally the build material ID may identify at least a build material name and a ratio of reused to fresh build material within the unfused build material, and wherein the validation data storage device comprises a single allowable build material ID identifying a predefined allowable build material name and a predefined allowable ratio of reused to fresh build material within the unfused build material.

Optionally the build material ID may identify at least a build material name, and optionally a ratio of reused to fresh build material within the unfused build material, and the post processing station may be s configured to generate successive dosed volumes of fresh and unfused build material identifiable by the same predefined allowable build material name, and optionally at the same predefined allowable ratio of reused to fresh build material within the unfused build material, and to write to the electronic tag of the respective build container holding the dosed volume at least one of:
a build material ID identifying the build material name and a ratio of reused to fresh build material within the unfused build material, or a link to said build material ID and ratio stored on the or a further data storage device; and
a source ID, identifying at least one of the plurality of 3D printers, and/or identifying said post processing station that generated the dosed volume, or a link to said source ID stored on the or a further data storage device.

Optionally each 3D printer may comprise a printer controller having a printer electronic tag reader in communication with a printer validation data storage device, wherein the printer validation data storage device comprises the allowable build material ID and/or the allowable source ID; wherein the printer controller is configured to:
read the electronic tag and thereby obtain the build material ID and/or source ID stored thereon or linked thereto;
determine whether the obtained build material ID and/or the obtained source ID corresponds to the allowable build material IDs and/or the allowable source ID, by comparing the obtained build material ID and/or the obtained source ID with said stored allowable build material ID and/or said stored allowable source ID; and:
upon determining that the obtained build material ID and/or the obtained source ID does not correspond to the allowable build material ID and/or the allowable source IDs, generate an alert that the obtained build material ID and/or the obtained source ID cannot be verified; or
upon determining that the obtained build material ID and/or the obtained source ID corresponds to the allowable build material IDs and/or to the allowable source IDs, accepting the dosed volume into the 3D printer for generating a further build volume.

Optionally the electronic tag of one or more of the build containers may store the 3D printer ID of at least one of the one or more 3D printers and/or the build container ID identifying said build container, and the validation data storage device of the post processing station and the printer validation data storage device of the 3D printer may store said 3D printer IDs and/or source IDs as allowable 3D printer IDs and/or allowable source IDs.

Optionally the electronic tag of each build container may store the 3D printer ID of a single one of the 3D printers, and the validation data storage device of the post processing station may store said 3D printer IDs as allowable 3D printer IDs and the printer validation data storage device of the 3D printer may stores said 3D printer IDs as a single allowable 3D printer ID.

Optionally each electronic tag may permanently store thereupon a source ID comprising at least one of a build container ID identifying said build container and a single 3D printer ID, and the validation data storage device of the post processing station may store the build container ID and/or the 3D printer ID as an allowable ID, and optionally wherein the printer validation data storage device stores the build container ID and/or the 3D printer ID as an allowable ID.

1. A post processing station for recovering unfused build material from a build volume produced by a 3D printer, the build volume comprising one or more 3D objects and unfused build material, the post processing station comprising a receiving section and a dosing section, wherein the receiving section is configured to receive a build container comprising a build volume and an electronic tag, the electronic tag storing at least one of a build material ID, and a source ID comprising one or more of a build container ID, a 3D printer ID and a post processing station ID, or a link to at least one of said IDs stored on a data storage device;
wherein the post processing station comprises a controller having an electronic tag reader in communication with a validation data storage device, wherein the validation data storage device comprises one or more stored allowable build material IDs and/or one or more stored allowable source IDs; wherein the controller is configured to:
upon receiving the build container at the receiving section, read the electronic tag and thereby obtain the build material ID and/or source ID stored thereon or linked thereto;
determine whether the said one or more obtained IDs corresponds to one of the said allowable IDs, by comparing the said one or more obtained IDs with said one or more stored allowable IDs; and:
upon determining that the obtained build material ID and/or the obtained source ID corresponds to one of said allowable IDs, accept the unfused build material into the receiving section for dosing, or
upon determining that the obtained build material ID and/or the obtained source ID does not correspond to one of said allowable IDs, generate an alert that the obtained build material ID and/or the obtained source ID cannot be verified.

2. The post processing station of claim 1 configured to receive a plurality of build containers, each comprising a corresponding electronic tag, wherein each electronic tag stores a single one of a plurality of 3D printer IDs, each 3D printer ID corresponding to a different 3D printer, and/or a single one of a plurality of build container IDs, each build container ID corresponding to a different build container; and wherein the validation data storage device stores a plurality of allowable 3D printer IDs corresponding to the plurality of 3D printer IDs and/or a plurality of allowable build container IDs corresponding to the plurality of build container IDs.

3.-4. (canceled)

5. The post processing station of claim 1, wherein the receiving section comprises a depowdering section configured to separate unfused build material from the one or more 3D objects, and wherein the post processing station comprises a dosing section configured to dose a dosed volume reusing recovered unfused build material; wherein, upon the controller determining that the build material ID and/or the source ID is an allowable build material ID and/or an allowable source ID, the controller is configured to control the post processing station to:
release the build volume into the depowdering section,
in the depowdering section, recover unfused build material from the build volume;
provide the or a further build container to the dosing section;
in the dosing section, transport a predetermined reuse amount of the recovered unfused build material to the or the further build container;
in the dosing section, transport a predetermined fresh amount of the fresh build material to the or the further build container; and
provide the electronic tag of the build container or the further build container with at least one of a new build material ID and/or an intended 3D printer ID.

6.-7. (canceled)

8. The post processing station of claim 1, comprising a depowdering section configured to separate unfused build material from the one or more 3D objects, and a dosing section configured to dose a dosed volume from recovered unfused build material and fresh build material; wherein, upon the controller determining that the build material ID and/or the source ID is not an allowable build material ID and/or an allowable source ID, the generated alert comprises instructions to purge the recovered unfused build material after releasing of the build volume into a depowdering section and separating the one or more 3D objects from unfused build material.

9. An additive manufacturing system comprising a post processing station according to claim 1, and one or more build containers, each build container comprising an electronic tag, and one or more 3D printers, each configured to generate a build volume comprising one or more 3D objects and unfused build material; wherein each 3D printer is configured to write to the electronic tag of a respective build container holding the build volume generated by the respective 3D printer at least one of:
a source ID that identifies at least one of said 3D printer or a link to said source ID stored on a data storage device;
a post processing station ID identifying the post processing station for which the build volume is intended or a link to said post processing station ID stored on a data storage device; and
a build material ID that identifies the unfused build material of the build volume.

10.-12. (canceled)

13. The additive manufacturing system of claim 9, wherein the electronic tag of one or more of the build containers stores the 3D printer ID of at least one of the one or more 3D printers and/or the build container ID identifying said build container, and wherein the validation data storage device of the post processing station and the printer validation data storage device of the 3D printer store said 3D printer IDs and/or source IDs as allowable 3D printer IDs and/or allowable source IDs; optionally wherein the electronic tag of each build container stores the 3D printer ID of a single one of the 3D printers, and wherein the validation data storage device of the post processing station stores said 3D printer IDs as allowable 3D printer IDs and the printer validation data storage device of the 3D printer stores said 3D printer IDs as a single allowable 3D printer ID.

14.-15. (canceled)

16. A method for controlling the provision of a build volume comprising one or more 3D objects and unfused build material to a post processing station configured to recover unfused build material from the build volume produced by a 3D printer, the build volume comprised within a build container having an electronic tag; wherein the electronic tag comprises a build material ID and/or a source ID, the source ID comprising at least one of a build container ID, a 3D printer ID and a post processing station ID, or a link to a data storage device comprising said one or more IDs, wherein the method comprises:
providing the build container to the post processing station;
electronically reading the tag and thereby obtaining the build material ID and/or source ID stored thereon or linked thereto;
determining whether the obtained build material ID and/or the obtained source ID is an allowable build material ID and/or an allowable source ID, by comparing the obtained build material ID and/or the obtained source ID with one or more stored allowable build material IDs and/or one or more stored allowable source IDs; and
based upon determining that the obtained build material ID and/or the obtained source ID is not allowable, generating an alert indicating that the obtained build material ID and/or the obtained source ID cannot be verified; or
based upon determining that the obtained build material ID and/or the obtained source ID is allowable, receiving the build volume into the post processing station, recovering unfused build material for reuse from the build volume; generating in the build container, or in a further build container, a dosed volume of reused build material and of fresh build material at a predefined build material ratio, and writing to the tag of the build container, or to a tag of the further build container, a new build material ID identifying said reused build material, and/or said dosed build material ratio, and, optionally, one or more intended 3D printer IDs.

17.-18. (canceled)

19. The method of claim 16, further comprising:
providing the dosed volume in said build container to the or a further 3D printer; electronically reading at said 3D printer the electronic tag of said build container;
comparing the new build material ID and the source ID to the one or more allowable build material IDs and/or one or more allowable source IDs stored on a printer validation data storage device comprised within or accessible by said 3D printer; and
upon determining that the obtained build material ID and/or the obtained source ID is not one of an allowable ID, generating an alert indicating that the dosed volume cannot be verified; or
upon determining that the obtained build material ID and/or the obtained source ID is one of an allowable ID, accepting the dosed volume into the 3D printer for use for generating a new build volume.

20. The method of claim 19, further comprising, at said 3D printer, storing the at least one new build material ID, and optionally storing the source ID comprising the post processing station ID; and generating and providing within another build container anew build volume comprising 3D objects and unfused build material; and
writing to the electronic tag of the new build volume the new build material ID identifying the unfused build material and/or a source ID comprising at least one of a 3D printer ID identifying said 3D printer and a post processing station ID identifying the or a further post processing station for which the new build volume is intended.

21.-22. (canceled)

23. The method of claim 16, comprising a cycle of steps of:
(a) at the 3D printer:
generating and providing the build volume in a build container comprising the electronic tag; and
writing to the electronic tag, or to the data storage device to which the tag provides a link, a source ID identifying at least one of the 3D printer and the post processing station for which the build volume is intended, and a build material ID identifying at least the unfused build material;
(b) providing the build container to the post processing station, and at the post processing station:
electronically reading the electronic tag and thereby obtaining the build material ID and/or source ID stored thereon or linked thereto, and, if the obtained build material ID and/or the obtained source ID is an allowable ID:
releasing the build volume into the post processing station;
recovering unfused build material from the build volume for reuse;
generating a dosed volume of reused build material and fresh build material; and
writing to the tag of the build container or to a further electronic tag of a further build container, or to a data storage device to which the tag provides a link, one of a new source ID and anew build material ID;
(c) providing the dosed volume to the 3D printer or to a further 3D printer; and at the 3D printer or the further 3D printer:
electronically reading the electronic tag and thereby obtaining the new source ID and/or new build material ID stored thereon or linked thereto;
comparing the one or more obtained IDs to one or more allowable build material IDs and/or one or more allowable source IDs; and if the obtained one or more IDs is one of said allowable IDs:
transferring the dosed volume into said 3D printer;
repeating the cycle of steps one or more times.

24. The method of claim 23, wherein the cycle comprises the same one or more build containers holding each build volume and dosed volume for transfer between the same 3D printer and the post processing station, optionally wherein the source ID comprises a build container ID permanently stored on the tag of each build container, the build container ID identifying said build container, and wherein the method comprises verifying the build volume and/or the dosed volume based on the build container ID being determined an allowable build container ID.

25. The method of claim 16, wherein, in the event that the obtained build material ID and/or the source ID is determined to be not allowable, the generated alert further comprises instructions indicating that recovered unfused build material is to be purged from the post processing station, and the method further comprises:
releasing the build volume into the post processing station;
recovering unfused build material from the build volume; and
purging the unfused build material from the post processing station.

26. A post processing station for dosing unfused build material and fresh build material for reuse by a 3D printer, the post processing station comprising a receiving section and a dosing section, wherein the receiving section is configured to receive a build container comprising unfused build material, wherein the build container comprises an electronic tag storing at least one of a build material ID, and a source ID comprising one or more of a build container ID, a 3D printer ID and a post processing station ID, or a link to at least one of said IDs stored on a data storage device;
wherein the post processing station comprises a controller having an electronic tag reader in communication with a validation data storage device, wherein the validation data storage device comprises one or more stored allowable build material IDs and/or one or more stored allowable source IDs; wherein the controller is configured to:
upon receiving the build container at the receiving section, read the electronic tag and thereby obtain the build material ID and/or source ID stored thereon or linked thereto;
determine whether the said one or more obtained IDs corresponds to one of the said allowable IDs, by comparing the said one or more obtained IDs with said one or more stored allowable IDs; and
upon determining that the obtained build material ID and/or the obtained source ID corresponds to one of said allowable IDs, accept the unfused build material into the receiving section for dosing, or
upon determining that the obtained build material ID and/or the obtained source ID does not correspond to one of said allowable IDs, generate an alert that the obtained build material ID and/or the obtained source ID cannot be verified.

27.-29. (canceled)

30. The post processing station of claim 26, wherein the dosing section comprises a fresh build material tank, and a load cell configured to support the build container or a further build container,
wherein the build container or the further build container is fluidically couplable to the receiving section and a fresh build material tank, respectively defining a reuse build material transport path and a fresh build material transport path;
wherein, upon the controller determining that the build material ID and/or the source ID of the build container is an allowable build material ID and/or an allowable source ID, the controller is further configured to control the post processing station to:
determine that the build container or the further build container is positioned on the load cell;
control the reuse build material transport path to transport unfused build material from the receiving section to the build container or to the further build container;
determine, based on a weight of unfused build material in the build container or in the further build container as detected by the load cell, an amount of fresh build material required to achieve a predetermined ratio of reuse build material to fresh build material;
control the fresh build material transport path to transport the determined amount of fresh build material into the build container or the further build container; and
optionally, provide the electronic tag of the build container or of the further build container with at least one of a new build material ID and/or an intended 3D printer ID.

31. The post processing station of claim 30, wherein the receiving section comprises a depowdering section and a recovery section, wherein the recovery section comprises a recovery tank,
wherein the depowdering section is configured to separate unfused build material from the one or more 3D objects, wherein the build container or the further build container is fluidically couplable to the recovery tank to define the reuse build material transport path;
wherein, upon the controller determining that the build material ID and/or the source ID received at the receiving section is an allowable build material ID and/or an allowable source ID, and before controlling the reuse build material transport path to transport unfused build material from the receiving section to the build container or to the further build container, the controller is configured to control the post processing station to:
release the build volume into the depowdering section; and
in the depowdering section, cause the build volume to be depowdered and the unfused build material to be transported from the depowdering section into the recovery tank.

32. The post processing station of claim 30, wherein, upon the controller determining that the build material ID and/or the source ID is not an allowable build material ID and/or an allowable source ID, the generated alert comprises instructions to purge the recovery tank of recovered unfused build material after releasing of the build volume into a depowdering section and separating the one or more 3D objects from unfused build material; and optionally wherein the controller is configured to prevent the unfused build material from entering the dosing section.

33. The post processing station of claim 30, wherein the source ID comprises a build container ID permanently stored on the electronic tag, wherein the validation data storage device comprises one or more stored allowable build container IDs, and upon providing the or a further build container to the dosing section of the post processing station, the controller is configured to obtain the build container ID from the electronic tag of the or the further build container, and determine, by comparing the build container ID with the one or more stored allowable build container IDs, whether the obtained build container ID corresponds to one of the allowable build container IDs; and, upon determining that the obtained build container ID does not correspond to one of the allowable build container IDs, generate an alert that the obtained build container ID cannot be verified.

34. (canceled)

35. An additive manufacturing system comprising a post processing station according to claim 26, and one or more build containers, each build container for containing unfused build material recovered from a build volume from one or more 3D printers and comprising an electronic tag; wherein the electronic tag of each build container is configured to store at least one of:
a source ID that identifies at least one of the 3D printers or a link to said source ID stored on a data storage device;
a post processing station ID identifying the post processing station for which the unfused build material is intended, and
a build material ID that identifies the unfused build material or a link to said build material ID stored on the or a data storage device.

36. (canceled)

37. The additive manufacturing system of claim 35, wherein the build material ID identifies at least a build material name, and optionally a ratio of reused to fresh build material within the unfused build material, and wherein the post processing station is configured to generate successive dosed volumes of fresh and unfused build material identifiable by the same predefined allowable build material name, and optionally at the same predefined allowable ratio of reused to fresh build material within the unfused build material, and to write to the electronic tag of the respective build container holding the dosed volume at least one of:
a build material ID identifying the build material name and a ratio of reused to fresh build material within the unfused build material, or a link to said build material ID and ratio stored on the or a further data storage device; and
a source ID, identifying at least one of the plurality of 3D printers, and/or identifying said post processing station that generated the dosed volume, or a link to said source ID stored on the or a further data storage device; and
wherein each 3D printer comprises a printer controller having a printer electronic tag reader in communication with a printer validation data storage device, wherein the printer validation data storage device comprises the allowable build material ID and/or the allowable source ID; wherein the printer controller is configured to:
read the electronic tag and thereby obtain the build material ID and/or source ID stored thereon or linked thereto;
determine whether the obtained build material ID and/or the obtained source ID corresponds to the allowable build material IDs and/or the allowable source ID, by comparing the obtained build material ID and/or the obtained source ID with said stored allowable build material ID and/or said stored allowable source ID; and:
upon determining that the obtained build material ID and/or the obtained source ID does not correspond to the allowable build material ID and/or the allowable source IDs, generate an alert that the obtained build material ID and/or the obtained source ID cannot be verified; or
upon determining that the obtained build material ID and/or the obtained source ID corresponds to the allowable build material IDs and/or to the allowable source IDs, accepting the dosed volume into the 3D printer for generating a further build volume.

38. (canceled)

39. The additive manufacturing system of claim 26, wherein the electronic tag of one or more of the build containers stores the 3D printer ID of at least one of the one or more 3D printers and/or the build container ID identifying said build container, and wherein the validation data storage device of the post processing station and the printer validation data storage device of the 3D printer store said 3D printer IDs and/or source IDs as allowable 3D printer IDs and/or allowable source IDs.

40.-41. (canceled)
